(19) United States
(12) Patent Application Publication
(10) Pub. No.: US 2003/0049052 A1
(43) Pub. Date: Mar. 13, 2003

(54) Developer container

(76) Inventors: Jui-Chi Wang, Wu-Chi Town (TW); Robin Hsu, Wu-Chi Town (TW); Ya Li Huang, Wu-Chi Town (TW); Mei Hsia Chang, Wu-Chi Town (TW)

Correspondence Address: MERCHANT & GOULD PC, P.O. BOX 2903, MINNEAPOLIS, MN, 55402-0903, US

(21) Appl. No.: 09/949,228

(22) Filed: Sep. 7, 2001

(51) Int. Cl. G03G 15/08

(52) U.S. Cl. 399/262

(57) ABSTRACT

A developer container in which the container body has an inwardly protruded spiral guide flange spirally forwardly extended to a developer supply port and defining a spiral flow guide way adapted to guide developer from the inside of the container body to the outside of the container body through the developer supply port, the developer supply port having a recessed developer accumulation area and a through hole through the center of the recessed developer accumulation area, the spiral guide flange having a beveled guide face extended to the recessed developer accumulation area.

### BACKGROUND OF THE INVENTION

The present invention relates to a developer container for use in a copy machine or the like and, more particularly to such a developer container, which prevents the formation of laminar flow when rotated to supply developer.

FIG. 1 shows a developer container constructed according to U.S. Pat. No. 5,528,349. The container body A of this structure of developer container comprises a developer supply hole C disposed near the front side thereof, and a spiral guide flange B adapted to guide developer toward the developer supply hole C. The spiral guide flange B has a front straight portion B1 spaced from the developer supply hole C by a space A1. This structure of developer container is still not satisfactory in function. When developer is going to be used up, a certain amount of developer residue is left in the space A1 and cannot be expelled out of the container body A. The developer residue will cause an environmental pollution when the used developer container is thrown away. Further, when continuously rotating the container body A to move developer out of the developer supply hole C, a laminar flow may occur, resulting a bridging effect and condensing of developer.

### SUMMARY OF THE INVENTION

The present invention has been accomplished to provide a developer container, which eliminates the aforesaid drawbacks. It is one object of the present invention to provide a developer container, which prevents the formation of developer residue. It is another object of the present invention to provide a developer container, which prevents the formation of laminar flow and condensing of developer. According to the present invention, the container body of the developer container comprises a plurality of flat flow guide portions and oblique flow guide portions alternatively spirally connected in series, an inwardly protruded spiral guide flange spirally forwardly extended to the developer supply port near the front developer filling opening thereof and defining with the flat flow guide portions and oblique flow guide portions a spiral flow guide way adapted to guide developer from the inside of the container body to the outside of the container body through the developer supply port. The developer supply port has a recessed developer accumulation area, and a through hole through the center of the recessed developer accumulation area. The spiral guide flange has a beveled guide face extended to the recessed developer accumulation area.

### BRIEF DESCRIPTION OF THE DRAWINGS

FIG. 1 is an elevational view of a developer container according to U.S. Pat. No. 5,528,349.

FIG. 2 is an exploded view of a developer container according to the present invention.

FIG. 3 is a longitudinal sectional view of the developer container according to the present invention.

FIG. 3A is an enlarged view taken along line A-A of FIG. 3.

FIG. 4 illustrates an alternate form of the container body according to the present invention.

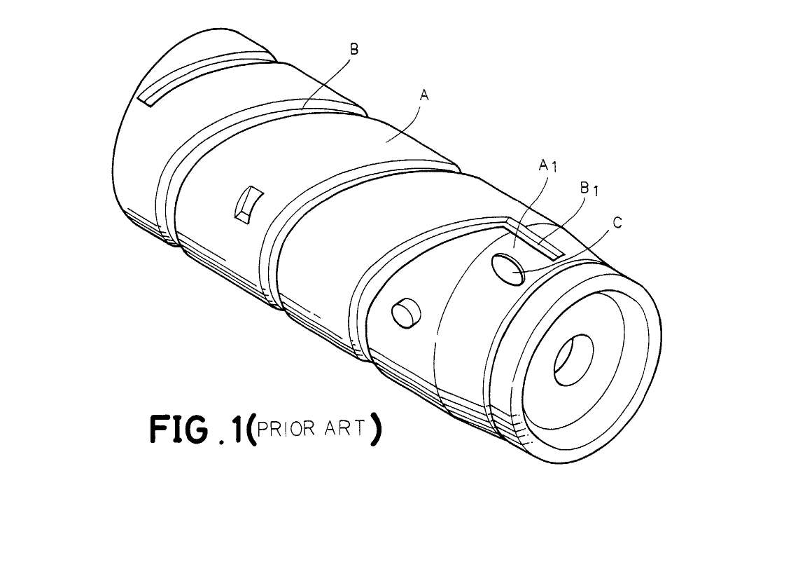

### DETAILED DESCRIPTION OF THE PREFERRED EMBODIMENT

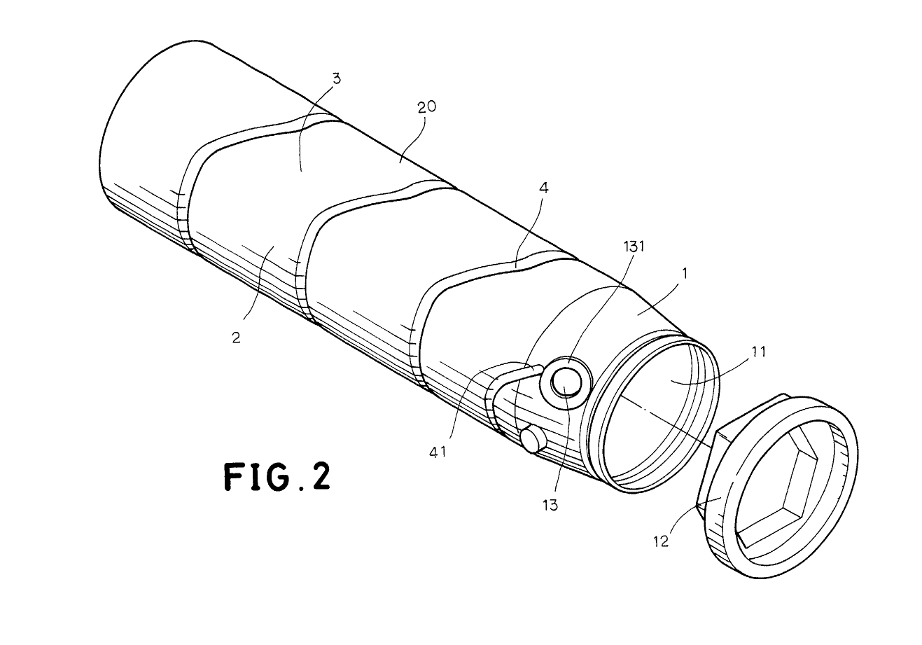

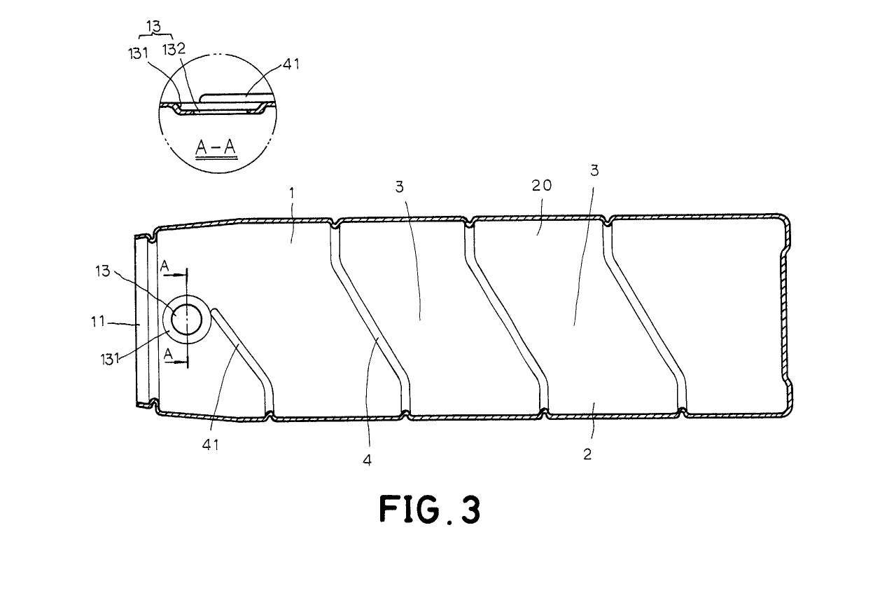

Referring to FIGS. 2 and 3, a developer container is shown comprising a cylindrical container body 1, and a cap 12. The cylindrical container body 1 has a front opening 11 through which developer is filled into the inside of the container body 1. The cap 12 is adapted to close the front opening 11.

The container body 11 comprises a developer supply port 13 adjacent to the front opening 11, a plurality of flat flow guide portions 2 and 20 alternatively arranged at two opposite lateral sides, a plurality of oblique flow guide portions 3 respectively connected between the flat flow guide portions 2 and 20, and an inwardly protruded spiral guide flange 4 spirally extended from the rear close side of the container body 1 to the developer supply port 13 and defining with the flat flow guide portions 2 and 20 and the oblique flow guide portions 3 a spiral flow guide way adapted to guide developer from the inside of the container body 1 to the outside of the container body 1 through the developer supply port 13. The developer supply port 13 comprises a recessed developer accumulation area 131, and a through hole 132 through the center of the recessed developer accumulation area 131. The spiral guide flange 4 has a beveled guide face 41 extended to the recessed developer accumulation area 131.

When rotating the container body 1, developer is forced by the spiral guide flange 4 to move forwards from one oblique flow guide portion 3 to one flat flow guide portion 2, and the from the flat flow guide portion 2 to the anterior flat flow guide portion 20. Continuously rotating the container body 1 causes developer to move smoothly in the spiral flow guide way along the spiral guide flange 4 toward the developer supply port 13. When moving to the front side of the container body 1, the flow of developer is stopped by the spiral guide flange 4 from passing to the front opening 1, and guided by the beveled guide face 41 of the spiral guide flange 4 to the recessed developer accumulation area 131 and then to the outside of the container body 1 through the through hole 132 for the use of the copy machine.

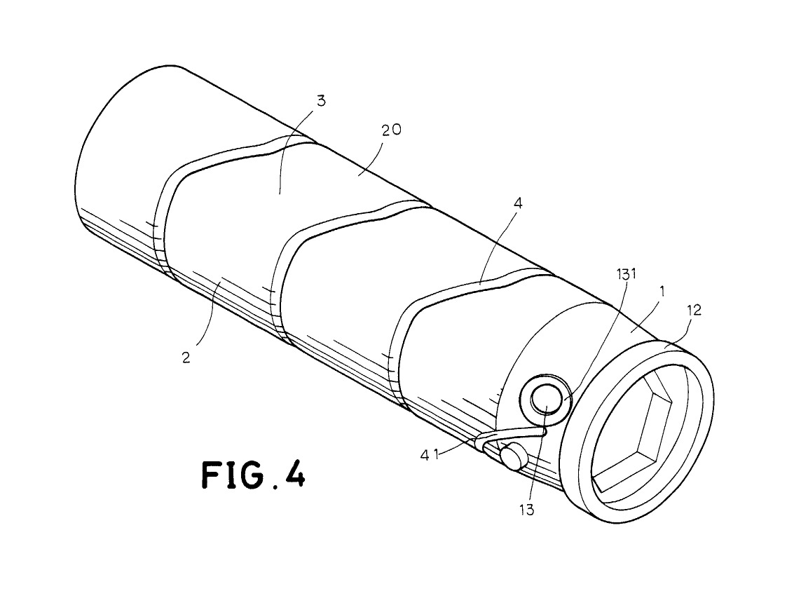

FIG. 4 shows an alternate form of the present invention. According to this alternate form, the beveled guide face 41 of the spiral guide flange 4 extends to one side of the developer supply port 13 adjacent to the front opening 11.

A prototype of developer container has been constructed with the features of FIGS. 2˜4. The developer container functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A developer container comprising a container body, said container body having a rear close side, a front developer filling opening, and a developer supply port adjacent to said front developer filling opening, and a cap adapted to close the front developer filling opening of said container body, wherein
said container body comprises a plurality of flat flow guide portions alternatively arranged at two opposite lateral sides, a plurality of oblique flow guide portions respectively connected between said flat flow guide portions, and an inwardly protruded spiral guide flange spirally extended from the rear close side of said container body to said developer supply port and defining with said flat flow guide portions and said oblique flow guide portions a spiral flow guide way adapted to guide developer from the inside of said container body to the outside of said container body through said developer supply port, said developer supply port comprising a recessed developer accumulation area and a through hole through the center of said recessed developer accumulation area, said spiral guide flange having a beveled guide face extended to said recessed developer accumulation area.

2. The developer container as claimed in claim 1 wherein said beveled guide face of said spiral guide flange is tangent to an upper side of said recessed developer accumulation area of said developer supply port.

3. The developer container as claimed in claim 1 wherein said beveled guide face of said spiral guide flange is tangent to a lower side of said recessed developer accumulation area of said developer supply port.
